(19) United States
(12) Patent Application Publication
(10) Pub. No.: US 2006/0176183 A1
(43) Pub. Date: Aug. 10, 2006

(54) Memory triggering device and method of use for the same

(76) Inventor: James Steven Jetton, Greenville, SC (US)

Correspondence Address: DORITY & MANNING, P.A., POST OFFICE BOX 1449, GREENVILLE, SC, 29602-1449, US

(21) Appl. No.: 11/055,541

(22) Filed: Feb. 10, 2005

(51) Int. Cl. G08B 23/00

(52) U.S. Cl. 340/573.1

(57) ABSTRACT

A device for triggering the memory of a primary caregiver of the presence of a child is provided. The memory triggering device includes a band of material having a front side and a back side. The band of material has a length that is longer than its width with the band of material having a first end and a second end that is distal from the first end along its length. A fastener is disposed on one of the sides of the band of material for enabling the band of material to be secured around an appendage of a wearer. The length of the band of material permits the second end to hang from the appendage of the wearer at a length that draws the attention of the wearer without becoming a hindrance to the mobility of the appendage or the wearer to remind the wearer of the presence of a child.

### FIELD OF THE INVENTION

The subject matter of the present invention relates to a memory triggering device to remind the caregiver wearing the memory triggering device of the presence of a child. The subject matter also relates to a method for using the memory triggering device.

### BACKGROUND OF THE INVENTION

Hyperthermia related injuries and deaths of children who are accidentally left within a car is a growing concern within the United States. According to data compiled by General Motors, 120 children died in parked cars from 1996-2000 due to exposure to heat. Over the last two years more than 75 children within the United States have passed away due to being left in cars where the internal temperature within the car cause the children's core temperature to reach a level that their body cannot handle. The problem of children being left in cars accounts for about ⅓ of the deaths for children under the age of 14 in non-traffic car-related fatalities.

Extreme heat effects infants and small children more quickly and dramatically then adults. Because of their size, the core temperature can increase three to five times faster then that of an adult. Heatstroke, or hyperthermia occurs when the body's core temperature reaches approximately 105° F. A child's core temperature can reach this level in a relatively short amount of time when a child is left in a car on a warm day. The temperatures can climb so rapidly within a car or other vehicle that they overwhelm the child's ability to regulate his or her internal temperature. In such an enclosed environment, a child's small body can go into shock and circulation to vital organs can fail quickly.

Even on a moderately warm day when the temperature is in the 70's, a car can heat up in relatively short amount of time to a point where a child's internal temperature can be affected. The suns short wave radiation easily penetrates through the windows of a car, or other vehicle. This short wave energy is absorbed by other objects in the car that it strikes including the dashboard, steering wheel, and child seat. These objects give off long wave radiation which is very efficient in warming up air trapped within a vehicle. It has been found that a previously air conditioned car that is exposed to the sun on a day when the temperature reaches 95° F. can have an internal temperature that exceeds 120° F. within 20 minutes and can reach temperatures of over 150° F. within 40 minutes. Therefore, leaving a child within a car for even a short amount of time can wreak havoc on a small child's thermoregulatory system.

Often, such deaths happen with no malice or forethought. A parent or other caregiver temporarily forgets and leaves a young child in the car that is parked in an area where it is exposed to the sun's radiation. While the caregiver is away, even if only for a short time, the internal temperature within the car can reach lethal limits. When the caregiver returns, he or she finds the child in shock or even worse, dead. Even on a mild day, the temperature may reach unacceptable levels within 50 minutes.

The reasons for such occurrences, while hardly excusable, can be understood. Human beings are creatures of habit. A change in someone's routine can disrupt the mental flow of someone's day and can cause one to forget what his or her responsibilities may be at any given time. For example, if a non-routine caregiver is given the responsibility to take a child to daycare one day, due to the person's normal routine, he or she may inadvertently forget that the child was in the backseat of a car due to other concerns such as work. If the child happens to fall asleep in the backseat and does not make any noise to draw attention to the presence of the child, the caregiver may automatically fall back into his or her normal routine forgetting about the child in the backseat as the child sleeps. The non-routine caregiver may then go to work and not realize the child is in the backseat until it is too late. Such an occurrence can particularly be the case for people who are naturally absent-minded and are preoccupied with other events and occurrences instead of being in tune with the present. Further, age and health may also play a roll in increasing the chance for forgetfulness for the caregiver.

In other cases, a caregiver may intentionally leave a child in the car. They may plan to leave them only for a short period of time, but then forget about the child due to tasks they are currently performing or by simply losing track of the amount of time the child has been left in the car.

Expensive alerting systems have been developed to decrease the likelihood of a child being left in a vehicle accidentally. Such devices include proximity alarms or the like. When the key of the car or some other device which the caregiver may have on his or her person is carried a specified distance from the car seat in which the child resides, an alarm will alert the caregiver of the occupied child seat. Thereby, the alarm reminds the caregiver to remove the child from the car.

Such systems are expensive to install and require complicated components which require maintenance and upkeep. Inherent problems in such sophisticated systems include battery life, radio transmission interference, etc. The systems also create a liability for the manufacturer in the event of a malfunction.

Therefore, a need for a simple solution exists to the current problems outlined above.

### SUMMARY OF THE INVENTION

According to certain aspects of the invention, a device for triggering the memory of a primary caregiver of the presence of a child is provided. The apparatus includes a band of material having a front side and a backside. The band of material has a length that is longer than its width. The band of material has a first end and a second end with the second end being distal from the first end along the length of the band of material.

A fastener is disposed on the backside of the band of material for enabling the band of material to be secured around an appendage of a wearer who is serving as the primary caregiver for the child. The fastener may include at least one first component positioned along the length proximal to the first end of the band of material as well as at least one second component positioned between the at least one first component and the second end of the band of material. The first and second components may form an engagement that promotes an easy disengagement of the first and second components to ensure release of the band of material from the appendage.

The length of the band of material permits its second end to hang from the appendage of the wearer at a length that draws the attention of the wearer without becoming a hindrance to the mobility of either the appendage to which it is attached or to the wearer. In this manner, the band of material draws attention to the wearer of its presence thereby reminding the wearer of the presence of the child.

According to certain other aspects of the invention, the second end of the band material may include a memory triggering mechanism to further remind the wearer of the presence of a child. The memory triggering mechanism may be a message or an image on the front side of the band of material such as the words “remember the child” or “don't forget the child.” Such a message may be printed, embroidered, or otherwise positioned on the band of material. Further, the memory triggering mechanism may be a noise producing device or an odor-producing device. In some embodiments the memory triggering mechanism may be a light source or a reflective device.

According to certain further aspects of the invention, a method for triggering the memory of the primary caregiver that a child is located in the backseat of a car is also provided. The method includes providing a memory-triggering device comprising a band of material that is accessible to a primary caregiver upon the caregiver placing a child in a vehicle. The band of material can then be secured to an appendage of the caregiver so at least a portion of the band of material dangles from the appendage. In this manner, the band of material draws the attention of the caregiver without becoming a hindrance to the mobility of the appendage or the caregiver. Thus, the caregiver will be reminded that the child is in the vehicle through the use of the memory triggering device if the caregiver for some reason forgets that the child is in the vehicle. Upon reaching a desired location, the caregiver will then remove the child from the vehicle and the band of material may be removed from the appendage of the caregiver upon the removal of the child from the vehicle.

Upon the removal of the memory triggering device, it may be placed in a location within the vehicle to remind the caregiver to put the memory triggering device on his or her desired appendage when a child is to ride in the vehicle, again.

All the features of the subject matter will be described in greater detail through the use of the appended figures.

### BRIEF DESCRIPTION OF THE DRAWINGS

A full an enabling disclosure of the present invention including the best mode thereof to one of ordinary skill in the art is set forth more particularly in the remainder of the specification, including references to the accompanying figures in which:

FIG. 1 illustrates a top view of a front side of an embodiment of the memory triggering device of the present subject matter;

FIG. 2 illustrates a bottom view of the backside of the memory triggering device shown in FIG. 1;

FIG. 3A illustrates a perspective view of a further embodiment of a memory triggering device attached around a forearm of a caregiver according to the present subject matter;

FIG. 3B shows a method of release to remove the memory triggering device shown in FIG. 3A from the forearm of the caregiver; and

FIG. 4 illustrates a perspective view of a caregiver using the memory triggering device shown in FIG. 1 with a child being located in a car seat in the back seat of a vehicle.

### DETAILED DESCRIPTION

Reference will now be made in detail to the presently preferred embodiments of the invention, one or more examples of which are shown in the Figures. Each example is provided to explain the invention, and not as a limitation of the invention. In fact, features illustrated or described as part of one embodiment can be used with another embodiment to yield still a further embodiment. It is intended that the present invention cover such modifications and variations.

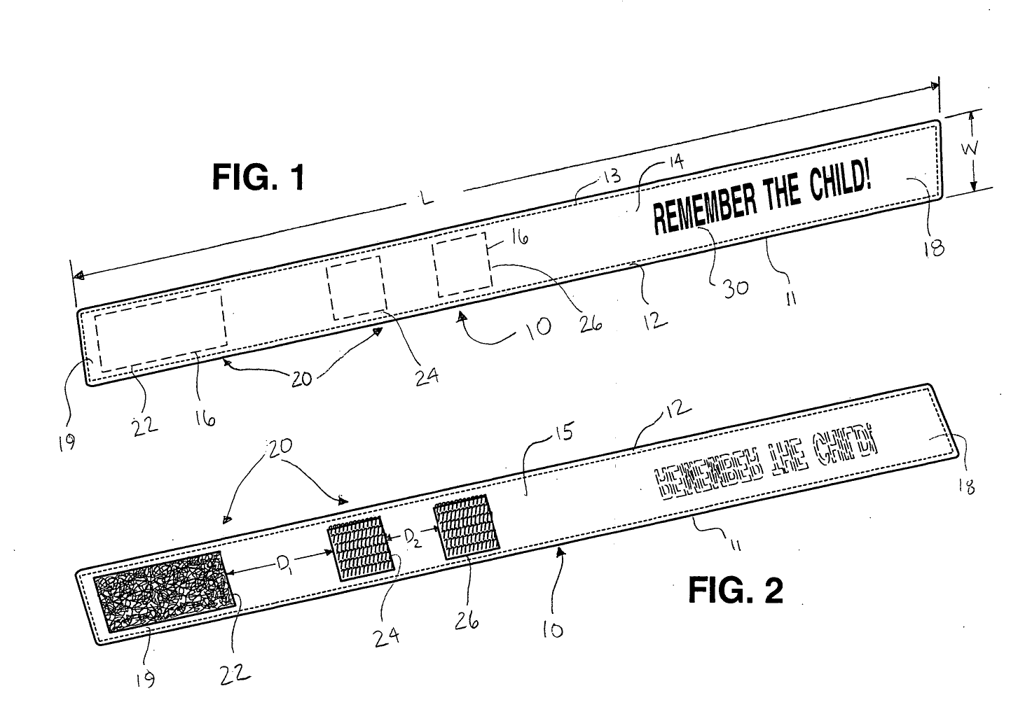

FIGS. 1, 2 and 4 show an exemplary embodiment of a memory triggering device, generally 10, which is used to remind a primary caregiver 50 of the presence of a child 70, for example, located in the backseat 62 of a vehicle 60. The memory triggering device 10 includes a band of material 11 having a front side 14 and a backside 15. As shown in FIG. 1, the length L of the band of material 11 is generally longer then its width W. A fastener 20 is located on a first end 19 of the band material 11. A memory enhancing mechanism 30 is placed on a second end 18 of the band of material 11. The memory enhancing mechanism in the embodiment shown is a message to jog the memory of the primary caregiver of the presence of a child.

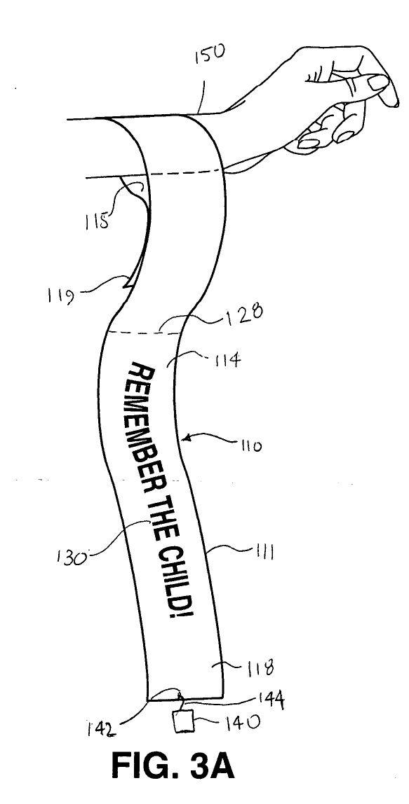

The fastener 20 on the band of material 11 includes at least one first component 22 and a pair of second components 24, 26. The first component 22 and the second components 24, 26 are both placed on the backside 15 of the band of material 11 to increase the chances that the fastener 20 may be easily disengaged in case of an emergency from the forearm or other appendage of the primary caregiver wearing it. The first component 22 mates with at least one of the pair of second components 24, 26. In the embodiment shown in FIG. 2, respective first and second components 22, 24, 26 comprise a hook and loop type fastening system. Second components 24, 26 make up the hook portion, while the loop portion of the fastener 20 is the first component 22 in the embodiment shown. In other applications of the present subject matter, however, the loop portion may be provided as the second components and the hook portion may be provided as the first component. Other type of fasteners or fastening systems may be used including snaps, magnets, clips, and the like.

In the embodiment shown, the first and second components 22, 24, 26 may be attached to the band of material 11 through stitching 16 to secure the fastener 20 to the band of material. The pair of second components 24, 26 are provided for adjustability of the memory triggering device 10. In this manner, the memory triggering device 10 is made to accommodate different appendages of different sized individuals from large men to petite women. The second component 24 is spaced at a distance D₁ from the first component 22 to provide a snug fit on smaller appendages such as the wrist of a primary caregiver who is petite in size. The second components which may be a plurality of components are spaced from each other at a distance D₂ which will allow for enough flexibility in providing a secure attachment around a variety of different sizes of appendages.

Other configurations of the fastener 20 may be used and may depend also on the type of fastener which is to be employed. For example, instead of having a pair of second components 22, 24, which are located between the first component 22 and the second end 18, a single long strip or swatch of the second component may be used. In such an embodiment, a longer piece of first component may also be used. Further, two first components may be provided at the first end 19 with one long second component thereby providing a similar adjustability in the memory triggering device 11. For fasteners such as snaps, a male or female end may be placed as a first component at the first end 19 of the band of material with a plurality of corresponding mating components placed between the first component and the second end 18 of the band of material 11. The spacing between such second components will allow a comfortable fit for a wide range of different sized caregivers. Further, such adjustability also allows for different placement of the band of material 11 on a different appendage other than a forearm or an upper arm on some wearer. For example, the band of material 11 may be secured around a lower portion of a caregiver's thigh on some individuals. The placement on the wrist, forearm, or upper arm, however, will allow the caregiver to wear the memory triggering device 10 without worrying about it interfering with his or her mobility.

The first and second components 22, 24, 26 are positioned so that at least a portion of the second end 18 of the band of material 11 will dangle from the appendage of the wearer thereby drawing the attention of the wearer to the memory triggering device 10. The length of the portion which dangles from the appendage of the wearer should be such that the dangling portion does not interfere with the activities of the wearer such as driving, walking, or other types of movement. In this manner, the wearer will be continually aware of the presence of the memory triggering device 10, thereby reminding the wearer of the presence of the child and/or his or her responsibility to care for the child. At the same time, the memory triggering device 10 is not a hindrance to the mobility of the wearer or his/her appendage which could endanger the caregiver when wearing the memory triggering device 10.

The length of the band of material 11 as stated above will generally be longer than its width. In certain embodiments, it is generally beneficial to have the length about 10 times larger than the width. This allows for an appropriate amount of dangling of the band of material 11 while still permitting a width which is not a hindrance or burden to the wearer. For example, a length of about 29 to 35 inches may be used with a width from about 3 inches to 3.5 inches. In such an embodiment, these proportions will allow for a portion of about 20 inches of the second end 18 to dangle or hang from a wrist or an upper forearm, for example. A length of 20 inches will aid in drawing the attention of the wearer to the memory triggering device 10 while at the same time not hinder the mobility of either the appendage to which it is attached or the wearer.

To further assist the memory of the caregiver wearing the memory triggering device 10, indicia such as a message or image may be printed, embroidered, or otherwise positioned on the second end 18 of the band of material 11. In the embodiment shown, the memory enhancing mechanism 30 is a message stating: “remember the child!” This message, for example, further reminds the wearer why he or she is wearing such a device. Other messages or images such as the child's name, initials, or likeness can be used, for example, to not only remind the wearer of the presence of the child, but to also personalize the memory triggering device 10.

Other types of memory enhancing mechanism may also be employed, for example, a noise-producing device, odor-producing device, a light source or the like. Further, a reflective device may also be attached to the second end 18 of the band material 11 to help draw the attention of the wearer to the memory triggering device 10. Through the association of the memory triggering device 10 with the presence of the child in the back seat of a vehicle, the wearer will be instantly reminded that care needs to be taken to remove the child from the vehicle once the caregiver and the child reach their destination.

Further, another memory enhancing mechanism of memory triggering device 10 is the color of the band of material 11. In certain embodiments, it would be beneficial for the band of material 11 to have at least a portion be a bright color. For examples, bright yellows, reds, oranges, greens, and the like are useful in catching the eye of the wearer to further help draw attention of the wearer to the device to remind the wearer that a child is in the vehicle.

The band of material 11 may be made of different types of material such as fabrics, films, extruded plastics, webs, non-wovens, or the like. In the embodiments shown in FIGS. 1 and 2, the band of material 11 is constructed from a nylon fabric. The weight of the fabric may be chosen based on its ability to facilitate drawing the attention of the wearer to the memory triggering device 10. At the same time, the fabric should be light enough to not become a hindrance or a burden to the wearer.

The nylon fabric for such use in the band of material 11 may have a weight of 2.5 ounces per square yard and 5 ounces per square yard. In many embodiments, the fabric weight of 3.1 ounces per square yard would be sufficient to help draw the attention of the wearer to the memory-triggering device 10 and, at the same time, would allow the cost of construction to be minimized, while not becoming a hindrance to the wearer. The nylon fabric may be constructed of yarns having a mass per unit length of 200 denier. However, other sizes and weights of yams and fabrics may be selected.

In general, it may be beneficial when choosing a fabric or other material for use as the band of material 11 to ensure that the fabric or material is breathable to promote comfort while still drawing the attention of the wearer as need. Also, it may also be beneficial to treat the fabric or material which will comprise the band of material 11 with a flame retardant substance. In some types of material, flame retardancy maybe inherent or a flame retardant substance may be included in the material as an additive during processing or formation of the material.

When a fabric is used to construct the band of material 11, it may be beneficial to include a hem 12 around the perimeter of the band of material 11 to prevent loose yam from snagging or catching different objects while the wearer is wearing the memory triggering device 10. By using a stitching 13 around the hem 12, the perimeter of the band of material 11 is kept smooth, which is aesthetically pleasing and increases the safety of wearing the memory-triggering device 10.

In general, the memory triggering device 10 is useful in reminding the wearer of the presence of a child. This means that the memory triggering device 10 is not only useful in reminding the caregiver that a child is in the vehicle, it may also be useful in designating which caregiver is the primary caregiver who is responsible for the safety and welfare of the child. For example, if a mother and father are on a vacation with a young child, the wearer of the band will know he or she is in charge of keeping an eye on the child and ensuring the safety of the child. Thereby, using the memory triggering device 10 prevents an incident where the parents may be separated and each thinks the other is caring for the child when in fact the child may be with neither of them.

Another use for the memory triggering device 10 may be to track multiple children by having multiple memory enhancing mechanisms placed on the second end 18 of the band of material 11. For example, if a bus driver is in charge of simply delivering eight children to their intended destination, he may have buttons, for instance, as memory enhancing mechanisms, which are attached to the second end 18 of the band of material 11 with each button representing a specific child. Once a child is safely returned to the desired location, a button may be removed to ensure a proper count of the children. Further, the names of the children may be on the buttons to identify if certain children have possibly gotten off at a stop where they were not supposed to. In this manner, multiple children can be tracked for their safety by a single individual.

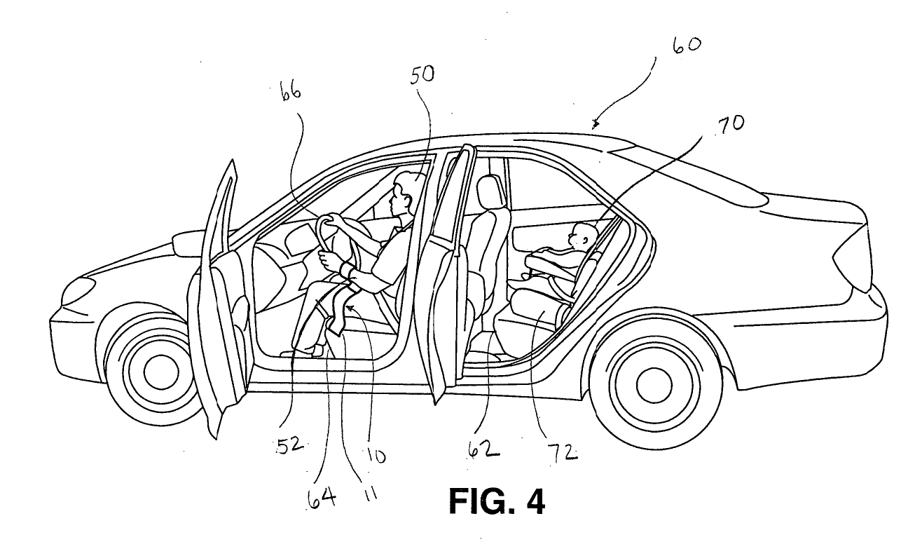

FIG. 4 illustrates the use of the memory triggering device 10 when a caregiver 50 is transporting a child 70. Once the child 70 is secured in his or her car seat 72 in the backseat 62 of a vehicle 60, the primary caregiver 50 may attach a memory triggering device 10 to his or her wrist or forearm 52. The memory triggering device 10, which comprises a band of material 11 is preferably provided at a position that is accessible to the caregiver 50 within the vehicle 60 either before, during or after the placement of the child in his or her car seat 72.

As stated above, the memory triggering device 10 may be secured to an appendage 52 of the caregiver 50 so that at least a portion of the band of material 11 dangles from the appendage 52 to draw the attention of the caregiver 50 without becoming a hindrance to the mobility of either the appendage 52 or the caregiver 50. In this manner, the caregiver 50 is reminded that the child 70 is in the vehicle 60 every time his attention is drawn towards the memory triggering device 10, thereby reminding the caregiver 50 of the presence of the child 70 within the vehicle 60. Upon reaching the desired location or designation, the child 70 may be removed from the vehicle 60. At this time, the memory triggering device 10 can be removed from the appendage 52 of the caregiver 50 and placed back in its designated location within the vehicle 60.

For example, the memory triggering device 10 may be placed in the driver's seat 64, on a steering wheel 66, or on or near the location of the car seat 72. For caregivers 50 who want to attach it to the individual car seat 72, the memory triggering device 10 may be placed on the handle of the car seat 72 or possibly stuck to the fabric or wrapped around an arm portion of the car seat 72. In this manner, every time the caregiver 50 uses the car seat 72, he or she is reminded to place the memory triggering device 10 on his or her forearm, or wrist, 52 before the child 70 is placed in the car seat 72. If the memory triggering device 10 is kept within the car, the caregiver 50 is reminded to place it on his or her forearm, or wrist, 52 once the caregiver 50 sees the memory triggering device 10 in the backseat 62 where the car seat 72 is located, or upon entering the driver's seat 64 if the memory triggering device 10 is located at the driver's seat 64 or the steering wheel 66. In this manner, the caregiver is reminded to wear the memory triggering device 10 to spark the memory of the caregiver of the presence of the child.

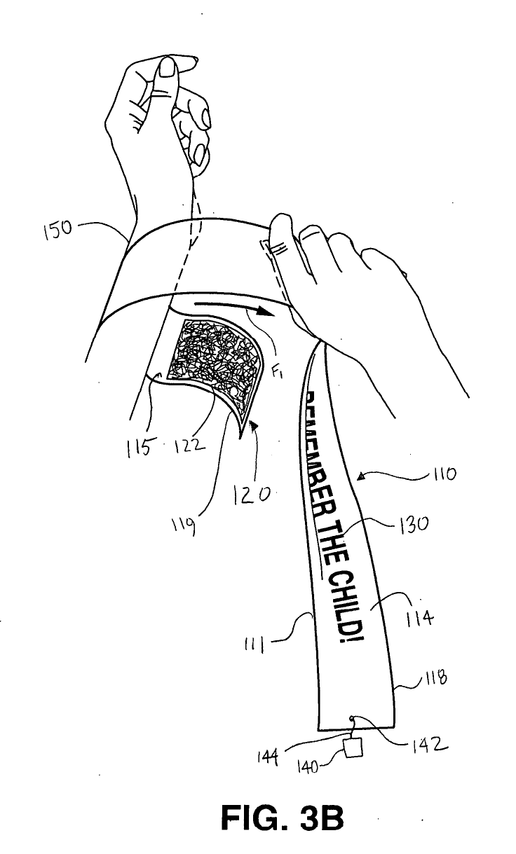

As stated above, the memory triggering device constructed of a band of material is designed to be easily releasable or constructed in a manner that prevents the opportunity of injury to the appendage or the caregiver wearing the memory triggering device due to the fact that the band of material obstructs mobility or somehow catches or snags on an object, which can lead to injury of the wearer. FIGS. 3A and 3B show two mechanisms which help to prevent such injuries due to immobility caused by a band of material 111 of a memory triggering device 10. As shown and described in FIGS. 1 and 2, first and second components of a fastener 120 are attached to the same side, usually a backside 115 of the band of material 111. By having both the first and second components of the fastener 120 on the same side of the band of material 111, easy disengagement of the first and second components is facilitated. In this manner, when the first component 122 meets with a second component (not shown), the band of material 111 may be secured to the wrist, or forearm, 152 of the wearer 150. The first and second components meet to loop around the wrist, or forearm, 152 of the wearer 150. In this construction, the wearer can easily disengage the first and second components by pulling in a direction F₁ away from the wrist, or forearm, 152 of the wearer 150 with a single hand.

Such an easy disengagement does not occur when one of either the first or second components of the fastener is placed on the front side and the other component on the backside of the band of material. Once the first and second components mate in such a construction, it becomes difficult to separate the fastener with a single hand because the band of material is wrapped around the wrist or forearm. As the band of material is pulled in the direction, such as direction F₁, away from the wrist or forearm of the wearer, the band of material has a tendency to rotate around the wrist or forearm. For this reason, the looping connection generated by having the first and second components of the fastener 120 attached to a single side such as back side 115 of the band of material 111, increases the ease of disengagement.

Further, the strength of the mating between the first and second component of the fastener 120 should be selected so that a minimal amount of force is required to pull the first and second component apart. Thereby, in an emergency or upon a snag or a catch of the band of material 111 on an object, the wrist, or forearm, 152 of the wearer 150 may be easily pulled free from the memory triggering device 110 by causing a disengagement of the first and second components of the fastener 120. For example, the force required to pull the components of the fastener 120 apart should be considered when deciding on the fastener 20 to be enployed within the memory-triggering device 110. The selection should be made such that the holding force allows the band of material 111 to stay one the wrist, or forearm, 152 of the wearer 150, while at the same time allowing easy disengagement if the band of material 111 becomes caught on an object or the wearer 150 is trying to free himself or herself from the memory triggering device 110.

The band of material 111 of the exemplary embodiment of the memory triggering device 110 shown in 3A and 3B is constructed of a film material. Perforations 128 may be made between the first end 119 and the second end 118 of the band of material 111. Such perforations 128 can also help prevent injury to or immobility of the wearer if the second end 118 of the band of material 111 becomes caught or snagged by an object. In such a case, the band of material 111 will easily tear along the perforations 128 to allow the wearer 150 to be free and to regain mobility of the wrist, or forearm, 152. In this manner, a secondary safety mechanism is provided within the band of material 111 to prevent possible injury and/or immobility.

FIGS. 3A and 3B also illustrate the use of a multiple memory enhancing mechanism 130, 140 on the memory triggering device 110. The first memory enhancing mechanism may be a message or image 130 printed, embroidered or otherwise positioned on the second end 118 of the band of material 111. A second memory enhancing mechanism 140 may be attached to the second end 118 as well, such as a noise-producing device, odor-producing device or light source. For example, a bell may be attached which would help further to draw the attention of the wearer 150 to the memory triggering device 110 to remind the wearer 150 of the presence of the child. The memory enhancing mechanism 140 has a connecting device 144, which is used to attach the memory enhancing mechanism 140 at a point 142 at the second end 118 of the band of material 111. Such a connecting device 144 may include a chain, string, hook, stitching, or the like to secure the second memory enhancing mechanism 140 to the band of material 111. In this manner, multiple features of the memory triggering device 110 will help to draw the attention of the wearer 150 to the memory triggering device 110 to remind the wearer 150 about any children that may be riding in the back of the vehicle or within the wearer's care. Such features include color, weight, width of the band of material, messages or images positioned on the band of material, noise-producing devices, odor-producing devices, light sources, reflective devices or materials, or the like.

Through the use of the memory triggering devices described herein, a primary caregiver will be easily reminded of the presence a child within their care. In particular, such a device is useful for reminding a wearer of the presence of a child in the back seat of a vehicle. In this manner, tragic accidents that could be easily avoided are prevented. Innocent young lives can thus be saved through the use of such a device.

It will be appreciated by those skilled in the art that various modifications and variations can be made in the present invention without departing from the scope of the invention. It is intended that the present invention include such modifications and variations as come within the scope of the appended claims and their equivalents.

What is claimed:

1. A device for triggering the memory of a primary caregiver of the presence of a child, said device comprising:
a band of material having a front side and a back side, said band of material having a length that is longer than its width with said band of material having a first end and a second end that is distal from said first end along its length;
a fastener disposed on one of said sides of said band of material for enabling said band of material to be secured around an appendage of a wearer; and
said length of said band of material permitting said second end of said band of material to hang from the appendage of the wearer at a length that draws the attention of the wearer without becoming a hindrance to the mobility of the appendage or the wearer to remind the wearer of the presence of a child.

2. A device as in claim 1, further comprising a memory enhancing mechanism disposed on said band of material to further remind the wearer of the presence of the child.

3. A device as in claim 2, wherein said memory enhancing mechanism includes at least one of a message, image, a noise-producing device, an odor-producing device, light source, or reflective device.

4. A device as in claim 2, wherein multiple memory enhancing mechanisms are used to track multiple children.

5. A device as in claim 1, wherein said band of material includes at least one bright color to draw the attention of the wearer.

6. A device as in claim 1, wherein said band of material comprises a nylon fabric.

7. A device as in claim 1, wherein said fastener includes at least one first component positioned along said length proximal to said first end and at least one second component position between said at least one first component and said second end.

8. A device as in claim 7, wherein said first and said second components are capable of an engagement to hold said first and second components together while being capable of a disengagement that requires minimal force to promote easy release of the band of material from the appendage, while still permitting said engagement of said first and said second components under normal use.

9. A device as in claim 7, wherein said fastener comprises a hook and loop fastener, one of said first and second components being comprised of hook material and the other of said first and second components being comprised of loop material.

10. A device as in claim 7, wherein said at least one second component comprises a plurality of second components to permit a customized fit around the appendage of the wearer.

11. A device as in claim 7, wherein said at least one first component comprises a plurality of first components to permit a customized fit around the appendage of the wearer.

12. A device for triggering the memory of a primary caregiver that a child is located in the back seat of a vehicle, said apparatus comprising:
a band of material having a front side and a back side, said band of material having a length that is longer than its width with said band of material having a first end and a second end that is distal from said first end along its length;
a fastener disposed on said back side of said band of material for enabling said band of material to be secured around an appendage of a wearer; and
said length of said band of material permitting said second end of said band of material to hang from the appendage of the wearer at a length that draws the attention of the wearer without becoming a hindrance to the mobility of the appendage or the wearer to remind the wearer that a child is in the vehicle.

13. A device as in claim 12, further comprising a memory enhancing mechanism disposed said band of material to further remind the wearer that the child is in the vehicle.

14. A device as in claim 13, wherein said memory enhancing mechanism includes at least one of a message, image, a noise-producing device, an odor-producing device, light source, or reflective device.

15. A device as in claim 13, wherein multiple memory enhancing mechanisms are used to track multiple children.

16. A device as in claim 12, wherein said band of material includes at least one bright color to draw the attention of the wearer.

17. A device as in claim 12, wherein said band of material comprises a fabric.

18. A device as in claim 17, wherein said fabric weighs between about 2.5 and 5 oz/yd².

19. A device as in claim 12, wherein said length of said band of material is about 30 inches.

20. A device as in claim 12, wherein said fastener includes at least one first component positioned along said length proximal to said first end and at least one second component position between said at least one first component and said second end.

21. A device as in claim 20, wherein said first and said second components are capable of an engagement to hold said first and second components together while being capable of a disengagement that requires minimal force to promote easy release of the band of material from the appendage, while still permitting said engagement of said first and said second components under normal use.

22. A device as in claim 20, wherein said fastener comprises a hook and loop fastener, one of said first and second components being comprised of hook material and the other of said first and second components being comprised of loop material.

23. A device as in claim 20, wherein said at least one second component comprises a plurality of second components to permit a customized fit around said appendage of said wearer.

24. A method for triggering the memory of a primary caregiver that a child is located in the back seat of a vehicle, said method comprising the steps of:
providing a memory triggering device comprising a band of material that is accessible to a primary caregiver upon the caregiver placing a child in a vehicle;
securing the band of material to an appendage of the caregiver so that at least a portion of the band of material dangles from the appendage so that the band of material draws the attention of the caregiver without becoming a hindrance to the mobility of the appendage or the caregiver;
reminding the caregiver that the child is in the vehicle through the memory triggering device as needed;
removing the child from the vehicle upon reaching a desired location; and
removing the memory triggering device from the appendage of the caregiver to which it is attached.

25. A method as in claim 26, wherein a fastener is disposed on the band of material for enabling the band of material to be secured around an appendage of a wearer, the fastener having at least one first component positioned along the length proximal to the first end and at least one second component position between the at least one first component and the second end, the first and the second components being capable of an engagement to hold said first and second components together while being capable of a disengagement that requires minimal force to promote easy release of the band of material from the appendage, while still permitting said engagement of said first and said second components under normal use

26. A method as in claim 26, wherein the caregiver places the memory triggering device on the appendage before the caregiver starts the vehicle.

27. A method as in claim 26, further comprising placing the memory triggering device in a location within the vehicle to remind the caregiver to put the memory triggering device on when a child is to ride in the vehicle.
